(19) United States
(12) Patent Application Publication
(10) Pub. No.: US 2005/0048988 A1
(43) Pub. Date: Mar. 3, 2005

(54) Method and apparatus for locating a telecommunication terminal

(76) Inventor: Christopher Reon Gentle, Gladesville (AU)

Correspondence Address: John C. Moran, Attorney, P.C., 4120 E. 115th Place, Thornton, CO, 80233, US

(21) Appl. No.: 10/652,914

(22) Filed: Aug. 28, 2003

(51) Int. Cl. H04Q 7/20

(52) U.S. Cl. 455/456.1

(57) ABSTRACT

An apparatus and method locate a portable telecommunication terminal for emergency telephone call to a public safety answering point by detecting the emergency telephone call, communicating the emergency telephone call to the public safety answering point, and enabling a transmission device in the portable telecommunication terminal so that the portable telecommunication terminal maybe located by personnel that are dispatched by the public safety answering point using a transceiver to locate the transmission device.

### TECHNICAL FIELD

This invention relates to locating a telecommunication terminal that has placed an emergency call.

### BACKGROUND OF THE INVENTION

Within the prior art, a problem exists in attempting to identify a portable telecommunication terminal that has placed an emergency telephone call. It is necessary to locate the portable telecommunication terminal so that assistance can be rendered to the user of the portable telecommunication terminal. Portable telecommunication terminals may be a cellular telephone, an in-building wireless telephone, an IP telephone, etc.

In the absence of obstructions, it is known within the prior art to utilize global positioning satellite (GPS) devices to determine the position of the portable telecommunication device and to convey this information to the emergency center. In addition, it is known within cellular telephone systems to utilize triangulation to locate portable telecommunication units.

Whereas the prior art techniques work reasonably well where there are no obstructions, GPS devices do not function well within buildings that utilize reinforced steel floors or roofs. In addition, the utilization of GPS devices adds a considerable amount of money to the cost of a portable telecommunication device.

Also, the technique of locating a portable telecommunication unit using triangulation suffers from the problem of reflective signals if there are buildings or other objects which can reflect the radio waves. In addition, in a multi-story building where the wireless base stations are located on floors, it is possible for a base station many floors removed to actually be picking up a signal from a wireless handset.

### SUMMARY OF THE INVENTION

An apparatus and method locating a portable telecommunication terminal for an emergency telephone call to a public safety answering point by detecting the emergency telephone call, communicating the emergency telephone call to the public safety answering point, and enabling a transmission device in the portable telecommunication terminal so that the portable telecommunication terminal maybe located by personnel that are dispatched by the public safety answering point using a transceiver to locate the transmission device.

### BRIEF DESCRIPTION OF THE DRAWING

FIG. 1 illustrates an embodiment of a wireless telecommunication system;

FIG. 2 illustrates an embodiment of a wireless telephone;

FIG. 3 illustrates, in flowchart form, operations performed by an embodiment;

FIG. 4 illustrates, in block diagram form, an embodiment of a telecommunication switching system with an IP softphone for implementing the invention;

FIG. 5 illustrates, in flowchart form, operations performed by an embodiment; and

FIG. 6 illustrates, in block diagram form, an embodiment of a telecommunication switching system with a telecommunication terminal for implementing the invention.

### DETAILED DESCRIPTION

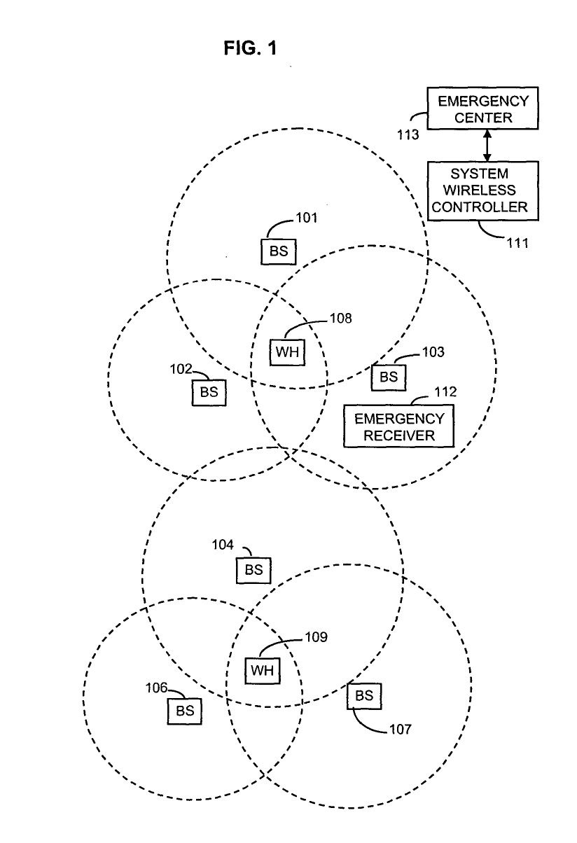

FIG. 1 illustrates a wireless telecommunication switching system. System wireless controller 111 controls the base stations 101-107. Wireless handsets 108 and 109 are also illustrated in FIG. 1. One skilled in the art would realize that there would be more base stations and wireless hand sets.

To understand the operations of the embodiment illustrated in FIG. 1, assume that the user of wireless handset 108 has dialed the emergency number. Wireless handset 108 recognizes the fact that the emergency number has been dialed. In one embodiment, wireless handset 108 will immediately activate the emergency transmission device within the wireless handset. In another embodiment, the actuation and frequency utilized by the emergency transmission device is controlled by control signals from emergency center 113. System wireless controller 111 is responsive to the placement of the emergency call by wireless handset 108 to interconnect wireless handset 108 to emergency center 113. Note, that wireless handset 108 as illustrated in FIG. 1 may utilize one of base stations 101-103. The transmission device may be active or passive. An active device would have its own power supply; whereas a passive device would receive its power from RF transmissions of an emergency receiver such as emergency receiver 112. Such a passive device is disclosed in U.S. Pat. No. 6,265,963, U.S. Pat. No. 6,600,443, and U.S. Pat. No. 6,486,780.

Assuming, for the sake of example, that wireless handset 108 is within a building or among buildings where there is a large reflection of radio frequencies used by the wireless handsets. In which case, the radio signals utilized by wireless handset 108 to place the emergency call may not be utilized to pinpoint the location of wireless handset 108. However, the general location of wireless handset 108 is known by the fact that it is utilizing one of the base stations 101-103. The emergency center 113 dispatches an emergency crew which posesses emergency receiver 112. Emergency receiver 112 utilizes the signal being transmitted from the emergency transmission device of wireless handset 108 to locate wireless handset 108. In one embodiment, the frequencies generated by the emergency transmission device are lower in frequency than that utilized for the voice transmission by wireless handset 108. These lower radio frequencies are less susceptible to reflection. Hence, emergency receiver 112 can utilize directional capabilities to locate wireless handset 108.

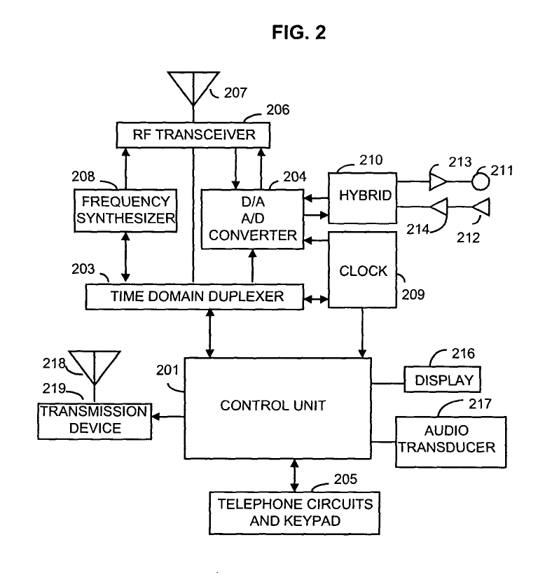

FIG. 2 illustrates, in block diagram form, an embodiment of a wireless handset. Components in this unit include control unit 201 and clock 209 for providing synchronization to: (1) control unit 201 (2) time domain duplexer (TDD) 203 and (3) combine digital-to-analog and analog-to-digital (D/A+A/D) converter 204. Also included in the illustrated wireless handset are RF transceiver 206, antenna 207, and frequency synthesizer 208. Telephone circuits and keypad section 205 permits dialing telephone digits and actuating control keys for placing and receiving telephone calls. Display 216 and audio transducer 217 are utilized by control unit 201 to provide feedback to the user and to alert the user of various situations.

Transceiver 206 comprises both a RF transmitter and a RF receiver. Transceiver 206 demodulates voice signals transmitted by a base station and couples these signals via the D/A section of converter 204 and hybrid 210 to loud speaker 212. Transceiver 206 receives its input analog speech signals from microphone 211. These analog speech signals are coupled to the transceiver via hybrid 210 and the A/D section of converter 204. Converter 204 converts the analog signals to digital signals which are then transmitted to RF transceiver 206. Conventional amplifiers 213 and 214 are employed for amplifying the analog speech signals obtained from microphone 211 and provided to loud speaker 212. Control messages are transferred via time domain duplexer 203 to control unit 201. In accordance with various embodiments, control unit 201 actuates and controls transmitter 219 which transmits the emergency signal via antenna 218.

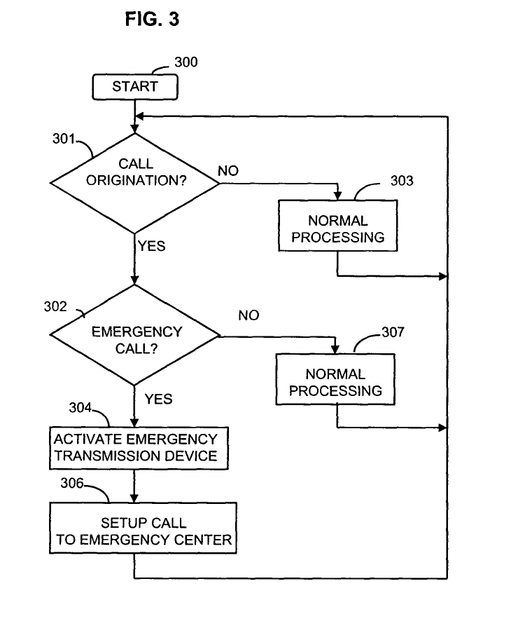

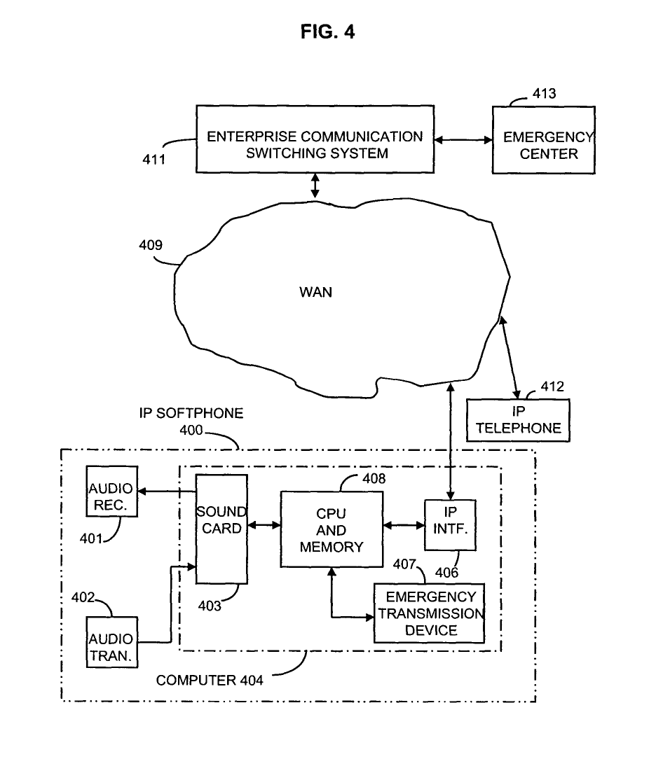

FIG. 3 illustrates, in flowchart form, operations performed by one embodiment. The operations illustrated in FIG. 3 can be performed by a wireless handset such as illustrated in FIG. 2 or by an IP telecommunication device such as illustrated in FIG. 4. Once started from block 300, decision block 301 determines if the telecommunication terminal is making a call origination. If the answer is no, block 303 performs normal processing before returning control to decision block 301. If the answer is yes in decision block 301, decision block 302 determines if the communication terminal is placing an emergency call. If the answer is no, block 307 performs normal processing before returning control back to decision block 301. If the answer in decision block 302 is yes, block 304 activates the emergency transfer, and block 306 sets up a call to the emergency center such as emergency center 113 of FIG. 1 before returning control back to decision block 301.

FIG. 4 illustrates another embodiment of the invention. FIG. 4 illustrates IP softphone 400 and IP telephone 412. Each of these telecommunication terminals has an emergency transmission device for use in accordance with the invention. Both telecommunication terminals utilize voice transmission utilizing the Internet protocol (IP). The characteristic of IP telecommunication terminals is that they can be plugged into any portion of WAN 409 at any time, and enterprise communication switching system 411 has no information concerning the physical location of these devices in a particular room. Enterprise communication switching system 411 does know the general part of WAN 409 in which the IP telecommunication terminal is connected.

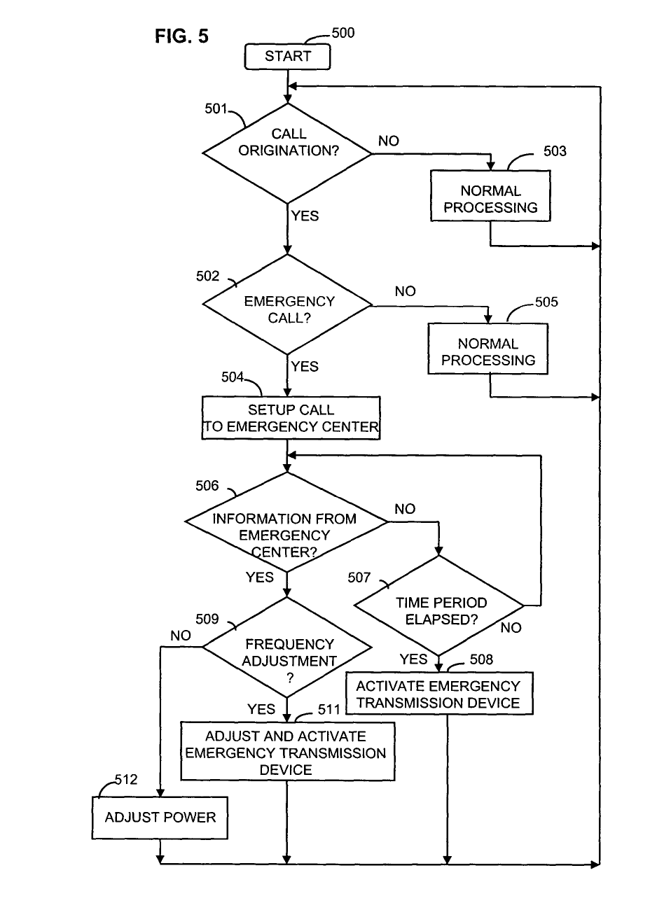

IP softphone 400 is responsive to audio information received from audio receiver 401 to convert this information to digital information via sound card 403. CPU and memory 408 then transmits the audio information to enterprise communication switching system 411 via IP interface 406. When audio information is received from enterprise communication switching system 411, via WAN 409 and IP interface 406, CPU and memory 408 utilize sound card 403 to convert this information to audio information which can be presented to the user via audio transmitter 402. CPU and memory 408 perform all of the control functions of IP softphone 400. When CPU and memory 408 determine that the user is placing an emergency call, CPU and memory 408 perform the operations illustrated in the embodiments of FIGS. 3 and 5.

IP telephone 412 is similar in construction to IP softphone 400 with the exception that IP softphone 400 utilizes computer 404 to provide the conductivity to WAN 409. IP telephone 412 would simply consist of a processor, IP interface, audio conversion circuits, and an emergency transmission device, with of course the necessary microphone and speaker such as audio receiver 401 and audio transmitter 402.

One skilled in the art would readily realize that enterprise communication switching system 411 could be replaced by a telecommunication gatekeeper which would provide the necessary control functions for IP softphone 400 and IP telephone 412.

FIG. 5 illustrates, in flowchart form, operations performed by an embodiment. In the embodiment illustrated in FIG. 5, the emergency center is given the capability of adjusting the frequency and power of the emergency transmission device. However, if the emergency center does not send such adjustment information within a predetermined time period, the emergency transmission device is automatically turned on at a preset power and frequency. The capability of being able to adjust the frequency and power of the emergency transmission device allows the emergency center to make these adjustments in order to take into account local situations.

After being started in block 500, decision block 501 determines if there is a call origination. If the answer is no, block 503 performs normal processing before returning control back to decision block 501. If the answer in decision block 501 is yes, decision block 502 determines if an emergency call is being placed. If the answer is no, decision block 505 performs normal processing before returning control back to decision block 501. If the answer in decision block 502 is yes, block 504 sets up a call to the emergency center.

Decision block 506 then determines if information has been received from the emergency center. In this context, decision block 506 is determining whether control information to control the emergency transmission device has been received. If the answer is no in decision block 506, decision block 507 determines if a predefined time period has elapsed since the placing of the call to the emergency center. If the answer is no, control is returned back to decision block 506. If the answer in decision block 507 is yes, block 508 activates the emergency transmission device and transfers control back to decision block 501. In another embodiment of the invention, block 508 returns control back to decision block 506 so that the emergency center can at a later point in time adjust the frequency and power.

Returning to decision block 506, if the answer is yes in decision block 506, decision block 509 determines if control information has been received from the emergency center to control the frequency of the emergency transmission device. If the answer is yes, block 511 adjusts and activates the emergency transmission device before returning control back to decision block 501. Note, if the emergency transmission device had already been activated, block 511 merely adjusts the frequency. In another embodiment, block 511 does not return control back to decision block 501 but rather returns control back to decision block 506 so that the emergency center can make further adjustments. If the answer is no in decision block 509, it is assumed that the emergency center is adjusting the power and control is transferred to block 512 to perform power adjustment on the transmission device before returning control back to decision block 501. In another embodiment, block 512 does not return control back to decision block 501 but transfers control back to decision block 506.

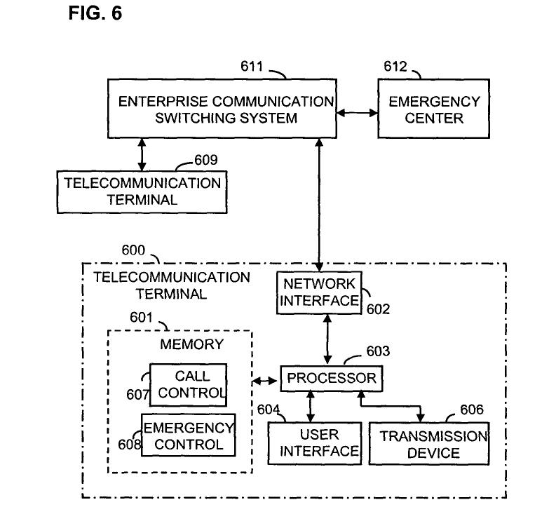

FIG. 6 illustrates another embodiment of the invention. FIG. 6 illustrates portable telecommunication terminals 600 and 609 connected to enterprise communication switching system 611. Enterprise communication switching system 611 is interconnected to emergency center 612. Portable telecommunication terminals 600 and 609 would be portable terminals using the Q.931 protocol or a proprietary digital protocol which are well known to those skilled in the art. Each of these portable telecommunication terminals has an emergency transmission device for use in accordance with the invention. The characteristic of these portable telecommunication terminals is that they can be plugged into enterprise communication switching system 611 at any time, and enterprise communication switching system 611 has no information concerning the physical location of these devices to a particular room. However, enterprise communication switching system 611 does know in general where the portable telecommunication terminal is connected.

Audio and control information is received from enterprise communication switching system 611 via network interface 606. Processor 603 performs all of the control functions of portable telecommunication terminal 600. When processor 603 determines that the user is placing an emergency call, processor 603 performs the operations illustrated in the embodiments of FIGS. 3 and 5. Processor 603 performs these emergency call operations by executing emergency control routine 608 stored in memory 601. Processor 603 performs these normal call operations by executing call control routine 607.

When the operations of devices 201, 408, or 603 are implemented in software, as is shown in FIGS. 3 and 5, it should be noted that the software can be stored on any computer-readable medium for use by or in connection with any computer related system or method. In the context of this document, a computer-readable medium is an electronic, magnetic, optical, or other physical device or means that can contain or store a computer program for use by or in connection with a computer related system or method. Devices 201, 408, or 603 can be embodied in any computer-readable medium for use by or in connection with an instruction execution system, apparatus, or device such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. For example, the computer-readable medium can be, but is not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured via optical scanning of the paper or other medium and then compiled, interpreted or otherwise processed in a suitable manner, if necessary, and stored in a computer memory.

In an alternative embodiment, where devices 201, 408, or 603 are implemented in hardware, devices 201, 408, or 603 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Of course, various changes and modification to the illustrated embodiments described above will be apparent to those skilled in the art. Such changes and modifications can be made without departing from the spirit and scope of the invention and without diminishing its intended advantages. It is therefore intended that such changes and modifications be covered by the following claims except insofar as limited by the prior art.

1. A method locating a portable telecommunication terminal for an emergency telephone call to a public safety answering point, comprising the steps of:
detecting an emergency telephone call being originated by the portable telecommunication terminal;
communicating the emergency telephone call to the public safety answering point; and
enabling a transmission device so that the portable telecommunication terminal maybe located by personnel that are dispatched by the public safety answering point using a transceiver to locate the transmission device.

2. The method of claim 1 wherein the step of enabling comprises the steps of storing identification information, and
activating the transmission device.

3. The method of claim 2 wherein the step of storing comprises the step of transmitting a command to the portable telecommunication terminal by the public safety answering point to enter the identification information.

4. The method of claim 2 wherein the step of storing comprises the step of transmitting the identification information to the portable telecommunication terminal by the public safety answering point.

5. The method of claim 1 wherein the portable telecommunication terminal is one of a wireless telephone, IP telephone device, or Q.931 telephone device.

6. The method of claim 1 wherein the transmission device is one of a transmitter or a transponder.

7. The method of claim 6 wherein the transponder is a radio frequency identification device being one of a passive or active type.

8. The method of claim 6 wherein the transmitter is an radio frequency transmitter.

9. A processor-readable medium for locating a portable telecommunication terminal for an emergency telephone call to a public safety answering point, comprising processor-executable instructions configured for:
detecting an emergency telephone call being originated by the portable telecommunication terminal;
communicating the emergency telephone call to the public safety answering point; and
enabling a transmission device so that the portable telecommunication terminal maybe located by personnel that are dispatched by the public safety answering point using a transceiver to locate the transmission device.

10. The processor-readable medium of claim 9 wherein the enabling comprises the steps of storing identification information, and
activating the transmission device.

11. The processor-readable medium of claim 10 wherein the storing comprises transmitting a command to the portable telecommunication terminal by the public safety answering point to enter the identification information.

12. The processor-readable medium of claim 10 wherein the storing comprises transmitting the identification information to the portable telecommunication terminal by the public safety answering point.

13. The processor-readable medium of claim 9 wherein the portable telecommunication terminal is one of a wireless telephone, IP telephone device, or Q.931 telephone device.

14. The processor-readable medium of claim 9 wherein the transmission device is one of a transmitter or a transponder.

15. The processor-readable medium of claim 14 wherein the transponder is a radio frequency identification device being one of a passive or active type.

16. The processor-readable medium of claim 14 wherein the transmitter is an radio frequency transmitter.

17. An apparatus for implementing the steps of claim 1.

18. An apparatus for implementing the steps of claim 3.

19. An apparatus for implementing the steps of claim 4.

20. A portable telecommunication terminal comprising:
means for connecting to a public safety answering point;
means for placing non-emergency type calls;
means for actuating a transmission device upon an emergency call being originated to the public safety answering point; and
means for placing the emergency call to the public safety answering point.

21. A portable telecommunication terminal comprising:
a computing device;
a memory for storing a program;
an emergency transmission device;
a user interface; and
the computing device by execution of the stored program enabling the emergency transmission device upon a call to a public safety answering point being originated via the user interface.

22. The apparatus of claim 21 wherein the computing device further storing identification information into the emergency transmission device and activating the emergency transmission device.

23. The apparatus of claim 21 wherein the emergency transmission device is one of a transmitter or a transponder.

24. The apparatus of claim 23 wherein the transponder is a radio frequency identification device being one of a active or passive type.
